(19) United States
(12) Patent Application Publication
(10) Pub. No.: US 2026/0025617 A1
(43) Pub. Date: Jan. 22, 2026

(54) SYSTEM FOR GENERATING SOUND LOCALIZED WITH RESPECT TO A LOCATION OF A FLOATING IMAGE

(71) Applicant: Disney Enterprises, Inc., Burbank, CA (US)

(72) Inventors: Lanny S. SMOOT, Thousand Oaks, CA (US); David KALBEITZER, Pasadena, CA (US)

(73) Assignee: Disney Enterprises, Inc., Burbank, CA (US)

(21) Appl. No.: 18/776,248

(22) Filed: Jul. 17, 2024

(51) Int. Cl. H04R 1/34; G02B 30/56; H04R 5/02; H04S 7/00

(52) U.S. Cl. CPC H04R 1/345; G02B 30/56; H04R 5/02; H04S 7/302; H04S 2400/11

(57) ABSTRACT

A system may comprise a first light source adapted to emit first light; a second light source adapted to emit second light; a beamsplitter adapted to: reflect a portion of the first light as reflected first light, and reflect a portion of the second light as reflected second light. The system may comprise a retroreflector, comprising a retroreflective material and a reflective surface, adapted to: reflect the reflected first light to provide a first image at a first location, and reflect the reflected second light to provide a second image at a second location. The system may comprise a first sound source adapted to output a first sound audible at the first location; a second sound source adapted to output a second sound audible at the second location. The system may comprise a controller adapted to cause the sounds to be output based on the light being emitted.

### BACKGROUND

Special lighting and visual effects may be provided at a venue. The special lightning and visual effects may include images. The images may provide information to individuals located at the venue.

### SUMMARY

In some implementations, a system, comprising a first light source adapted to emit first light; a second light source adapted to emit second light; a beamsplitter adapted to: reflect a portion of the first light as reflected first light, and reflect a portion of the second light as reflected second light; a retroreflector, comprising a retroreflective material and a reflective surface, adapted to: reflect the reflected first light to provide a first image at a first location, and reflect the reflected second light to provide a second image at a second location; a first sound source adapted to output a first sound audible at the first location; a second sound source adapted to output a second sound audible at the second location; and a controller adapted to: cause the first sound source to output the first sound based on the first light being emitted, and cause the second sound source to output the second sound based on the second light being emitted.

In some implementations, a first light source adapted to emit first light; a second light source adapted to emit second light; a beamsplitter adapted to: reflect a portion of the first light as reflected first light, and reflect a portion of the second light as reflected second light; a reflective element adapted to: reflect the reflected first light to provide a first image at a first location, and reflect the reflected second light to provide a second image at a second location; a first sound source adapted to output a first sound that is audible at the first location and inaudible at the second location; and a second sound source adapted to output a second sound that is audible at the second location and inaudible at the first location.

In some implementations, a method performed by a controller, the method comprising: causing a first light source to emit first light to cause a first image to be provided at a first location; causing a second light source to emit second light to cause a second image to be provided at a second location; cause a first sound source to output a first sound at the first location based on the first light source emitting the first light; and cause a second sound source to output a second sound at the second location based on the second light source emitting the second light.

### BRIEF DESCRIPTION OF THE DRAWINGS

FIG. 1 is a diagram of an example system described herein.

FIG. 2 is a diagram of an example system described herein.

FIG. 3 is a diagram of an example system described herein.

FIG. 4 is a diagram of an example system described herein.

FIG. 5 is a diagram of an example system described herein.

FIG. 6 is a diagram of example components of one or more devices of FIGS. 1-5.

FIG. 7 is a flowchart of an example process relating to generating sounds at locations of floating images.

### DETAILED DESCRIPTION

The following detailed description of example implementations refers to the accompanying drawings. The same reference numbers in different drawings may identify the same or similar elements.

Special lighting and visual effects may be provided at a venue that includes one or more guests. The special lightning and visual effects may include images. In some situations, the image may include a two-dimensional (2D) or a three-dimensional (3D) image that appears to be floating in space. Such images may be hereinafter referred to as “floating images.”

In some examples, the floating images may be generated using an image system that includes retroreflective materials, beamsplitters, curved mirrors, and/or lenses, among other examples. The floating images may be generated to appear to not possess an apparent source. Additionally, or alternatively, the floating images may be generated to appear to provide, to the one or more guests, an impression that the floating images may be touched like physical objects. The floating images may be generated for the purpose of providing information to the one or more individuals and/or for the purpose of entertaining the one or more individuals.

In some examples, the floating images may be provided with background sound effects that may enhance the guest experience. In some cases, an individual interacting with a floating may trigger a sound that may be synchronized with the interaction. The interaction may include the individual attempting to touch the floating image, attempting to pass a hand through the floating image, and/or the floating image moving toward the individual and colliding with the individual, or with a prop wielded by the individual. In some cases, the interaction may be synchronized with the sound. For example, the sound may be output simultaneously (or substantially simultaneously) with the interaction.

In current practice the sound is not perceived as being local with respect to a location of the floating image (e.g., an actual or physical location of the floating image). In other words, the sound is perceived as being distant with respect to the location of the floating image. By being perceived as distant from the location of the floating image, the perception of the sound may negatively affect the guest experience regarding the floating image.

In some situations, the floating image may be generated in a manner to appear to move toward the individual or away from the individual. While the floating image may be moving toward or away from the individual, the sound may not follow the movement of the floating image. In other words, the sound may be perceived as remaining stationary (e.g., the sound may be perceived as remaining at the same location). By remaining stationary, the sound may negatively affect the guest experience regarding the floating image (e.g., regarding the movement of the floating image).

In another case of a moving image, the moving image may actually appear to be a sequence of physical objects spaced at a sequentially larger distance from the imaging system such that, to the guest, the moving image appears to be moving closer or further away as each instance of the object is illuminated. While the moving image may be appearing to move closer or further away from the guest, the guest does not perceive the sound to be moving with the moving image. In contrast to the moving image, the floating image may appear to more or less maintain a position in space (e.g., a location in space).

Based on the foregoing, when floating images (2D and/or 3D) are displayed in the current art, the overall sound for the guest experience may be outputted (or emitted) at locations distant from physical locations of the floating images. In this regard, the sound that the floating images might be expected to output comes from a location that is remote from the locations of the floating images, thereby decreasing a sense of reality of the floating images. Accordingly, a need exists to improve guest experience regarding floating images and sounds associated with the floating images.

Implementations described herein are directed to a system that outputs sounds at locations of corresponding images (e.g., locations where floating images are displayed) at a venue. For example, the system may output a sound at an exact location (e.g., a physical location) of a floating image in manner to cause a guest to perceive (or believe) that the floating image is actually outputting the sound (e.g., to create a sensation that the floating image is actually outputting the sound).

Alternatively, the system may output the sound within a distance of (e.g., close enough to) the floating image to the floating image in a manner to cause a guest to perceive (or believe) that the floating image is actually outputting the sound. The venue may include movie theaters, theaters (e.g., for theatrical performances on stage), stadiums (e.g., for music concert performances), immersive theater attractions, theater attractions, escape rooms, hotels or business (e.g., in lobbies), malls or shopping centers, storefronts, tradeshows, and/or classrooms (e.g., for educational purposes).

In some cases, the floating image may be stationary. For example, the floating image may more or less maintains a position in space (e.g., a location in space). The sound may be outputted at the location or near the location. Alternatively, the floating image may be mobile. For example, the floating image may be an object that moves (or appears to move) closer to a guest, moves (or appears to move) away from the guest, and/or moves (or appears to move) to lateral sides of the guest (e.g., moves to left or right as opposed to in and out). In this regard, as the floating image appears to be floating towards the guest, the sound may be perceived as approaching the guest. As the floating image appears to retreat or move left to right, the sound may be perceived as retreating or as moving left or right with the floating image.

The floating images may be generated using light sources in combination with elements, such as retroreflective components, curved surfaces (e.g., a curved light reflective mirror), steam, fog, lenses, and/or holographic display components, among other examples. As an example, the light sources may include light emitting diodes (LEDs). In some examples, the light sources may emit light that is reflected, refracted, retroreflected, or other means by which floating images may be generated at various locations based on the operations performed on the originating light.

The sound may be generated using sound sources that may include ultrasonic transducers, such as ultrasonic speakers (e.g., ultrasonic loudspeakers). The ultrasonic transducers may be directional speakers. Alternatively, the sound sources may include conventional speakers (e.g., conventional loudspeakers).

In some examples, the sound sources may be positioned in a manner to cause the sound sources to output sound at locations of the floating images. In some examples, the sound sources (e.g., the ultrasonic speakers) may be directly aimed at the locations of the floating images. For example, a first sound source may be aimed at a first location of a first floating image, a second sound source may be aimed at a second location of a second floating image, and so on. Alternatively, the first sound source may be aimed at a first area that includes that the first location, the second sound source may be aimed at a second area that includes the second location, and so on. The first sound source may be positioned at a distance from the first location such that a range (of the first sound source) enables sound (outputted by the first sound source) to be perceived at the first location. Similarly, the second sound source may be positioned at a distance from the second location such that a range (of the second sound source) enables sound (outputted by the second sound source) to be perceived at the second location.

In some examples, the sound sources may output sound that is reflected such that the reflected sound is output at the locations of the floating images. For example, a third sound source may output a third sound that is reflected and output at a third location of a third floating image, a fourth sound source may output a fourth sound that is reflected and output at a fourth location of a fourth floating image, and so on. Alternatively, the third sound may be reflected and output at a third area that includes the third location, the fourth sound may be reflected and output at a fourth area that includes the fourth location, and so on.

In some implementations, the system described herein may include a controller adapted to control operations of the light sources and the sound sources. For example, the controller may cause the light sources to emit light and may cause the sound sources to output sound at the same time (or substantially at the same time). For instance, the controller may cause the first light source to emit light and may cause the first sound source to output, at the same time (or substantially at the same time), the first sound at the first location. Similarly, the controller may cause the second light source to emit light and may cause the second sound source to output, at the same time (or substantially at the same time), the second sound at the second location. The first sound may be different than the second sound.

In some implementations, the controller may control the operations of the sound sources based on interactions with light emitted by the light sources. For example, the controller may cause the sound sources to output sound based on determining that the guest has interacted with the light (e.g., based on determining that the guest has deflected the light using a hand or another body part and/or using an object). For instance, the controller may cause the first light source to emit light and may monitor signals indicating whether the guest has interacted with the light (or interacted with an image generated based on the light). The light may cause an image (e.g., a floating image) to be generated at the first location. In some examples, one or more camera devices may capture video data of an area that includes the first location. The video data may be analyzed (e.g., by the controller) to determine whether the guest interacted with the light or the image. In some examples, light sensors may be provided in the area. The light sensors may generate sensor data indicating whether the light has been obstructed by the guest. Based on the video data and/or the sensor data, the controller may determine whether the guest has interacted with the light. The controller may cause the first sound source to emit the first sound to cause the first sound to be perceived at the first location.

In some examples, the controller may cause the light sources to emit light according to a particular pattern (e.g., sequentially) to simulate a movement of the floating images. The controller may cause the sound sources to emit sound sequentially in a similar manner. The first sound emitted by the first sound source may be different than the second sound emitted by the second sound source. In some instances, the controller may cause a different sound to be emitted based on determining that the guest has interacted with the light. By causing the sound sources to emit the sound sequentially, the sound may be perceived as moving with the floating images.

In some implementations, the controller may monitor signals from the light sources and control the operations of the sound sources. The controller may receive the signals from the light sources and the signals may indicate whether the light sources have emitted light.

For example, based on monitoring the signals, the controller may determine whether the first light source has emitted first light. Based on determining that the first light source has emitted the first light, the controller may determine a sound source that is associated with the first light source. For example, the controller may determine that the first light source is associated with the first sound source (e.g., based on information stored in a data structure).

In some examples, the data structure may indicate that the first light source is associated with the first sound source, that the second light source is associated with the second sound source, and so on. As explained above, the first sound source may be adapted to output the first sound at the first location of the first floating image generated by the first light emitted by the first light source. In some situations, a sound source (such as the first sound source) may be associated with an area. Accordingly, the sound source may be associated with multiple light sources that emit light to create floating images in the area.

Based on determining that the first light source is associated with the first sound source, the controller may cause the first sound source to output the first sound. The first sound may be outputted at the first location of the first floating image. The controller may cause the second sound source to output the second sound in a similar manner.

In some situations, the first sound source may output the first sound using a component (of the display system) used to generate the first floating image. For example, the first sound may be output at the first location using a beamsplitter that is used to reflect the first floating image at the first location. For example, the beamsplitter may reflect the first sound to cause the first sound to be audible at the first location. By using the component in this manner, implementations described herein may reduce a size of the system, may reduce a cost associated with the system, and may improve coordination between the first floating image and the first sound.

In light of the foregoing, implementations described herein may output sound at a physical location of a floating image in a manner to cause a guest to perceive (or believe) that the sound is emanating from the physical location, with the sound source being provided at a different location. Accordingly, implementations described herein improve guest experience with respect to floating images.

Implementations described herein may link (or coordinate) floating images with sound, thereby increasing the reality of moving images and creating more realistic floating image special effects. In this regard, visual stimuli are combined with audible stimuli to improve a realistic aspect of the floating images. A stationary floating image will be able to present realistic sounds that appear to be originating directly from the floating image rather than from a remote location.

With respect to moving floating images, for instance in which ghosts are flying through a haunted environment, the ghosts may come up close to a guest and whisper in an ear of the guest (e.g., whisper a personal message). The personal message may be inaudible to guests located somewhat remote from the apparition of the ghost (e.g., based on the personal message being emitted by an ultrasonic speaker, such as a highly directional ultrasonic speaker). Implementations described herein may create the perception of audio being synchronized with a visual element that is stationary or moving through space, thereby improving guest experience with respect to visual elements that include floating images.

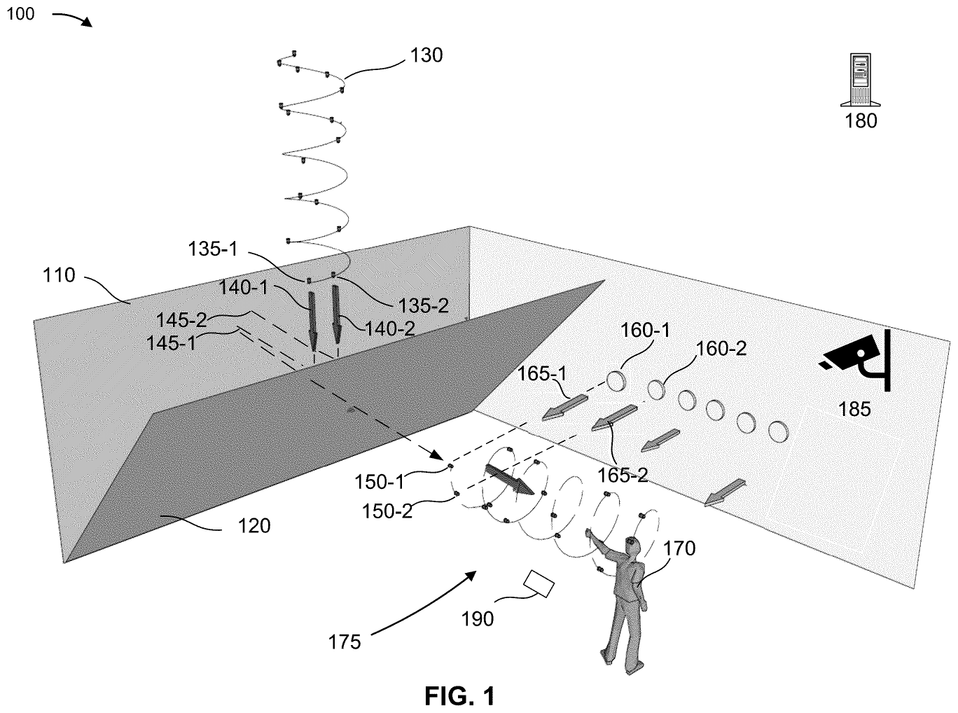

FIG. 1 is a diagram of an example system 100 described herein. As shown in FIG. 1, system 100 may include a retroreflector 110, a beamsplitter 120, a light source assembly 130 including a first light source 135-1 and a second light source 135-2 (collectively “light sources 135”), a plurality of sound sources including a first sound source 160-1 and a second source 160-2 (collectively sound sources 160), a controller 180, a camera device 185, and a light sensor 190.

Retroreflector 110, beamsplitter 120, and light sources 135 may form a display system adapted to generate floating images. Sound sources 160 may form a sound system adapted to generate sounds 165 that are audible at locations of the floating images. Retroreflector 110 may include a retroreflective material and a reflective surface. The retroreflective material may be used to reproduce floating images at a distance from the display system. In some cases, the retroreflector may advantageously blur a pinpoint floating image, such that the floating image can be imagined as a flying object that is moving closer guest 170, accompanied by sound. In some examples, retroreflector 110 may include a retroreflective sheet. In some examples, beamsplitter 120 may include a half-mirror (e.g., a mirror that appears reflective on one-side and transparent on another side).

Light source assembly 130 may include a spiral of sequentially lit light sources 135. In some examples, light sources 135 may include LEDs. Light sources 135 may emit light that is reflected and perceived as floating images at a distance from the display system. The floating images may be provided, to a guest 170, at different locations in a display area 175. In some implementations, camera device 185 and light sensor 190 may be provided in display area 175. Camera device 185 may capture video data of display area 175. The video data may be analyzed to indicate whether guest 170 is interacting with the floating images. Light sensor 190 may generate sensor data indicating whether guest 170 is interacting with the floating images. For example, the sensor data may indicate whether light (generated by light sources 135) is being obstructed in display area 175.

In some examples, sound sources 160 may include ultrasonic transducers. For example, sound sources 160 may include highly directional ultrasonic speakers (e.g., ultrasonic loudspeakers). Sound sources 160 may be directed at the different locations in display area 175. Accordingly, sound sources 160 may output sounds that are audible at the different locations. For example, first sound source 160-1 may output a first sound 165-1 that is audible at a first location of a floating image generated by first light source 135-1, second sound source 160-2 may output a second sound 165-2 that is audible at a second location of a floating image generated by second light source 135-2, and so on. In other words, first sound 165-1 may be perceived as being emitted from the first location, second sound 165-2 may be perceived as being emitted from the second location, and so on.

Sound sources 160 may be used to provide audio that appears to come from each of the floating images. A retroreflective system (including retroreflector 110) may be used to create a floating image, and sound sources 160 (provided on the lateral side of guest 170) may emit directional sound corresponding to the physical distance of the floating image from a front of display area 175.

As shown in FIG. 1, ultrasonic directional sound sources 160 (e.g., ultrasonic directional sound sources) may be provided on a lateral side of guest 170. In some situations, sound sources 160 may be provided on a first lateral side and a second lateral side of guest 170. In this regard, sound sources 160 may not only provide directional sound closest to the apparent location of a floating image, but also provide stereo cues that even further define the location of the floating image. Additionally, or alternatively, sound sources 160 may be provided above guest 170 (e.g., on a ceiling). Additionally, or alternatively, sound sources 160 may be provided on a ground surface.

Controller 180 may include one or more devices adapted to control operations of light sources 135 and sound sources 160. For example, controller 180 may cause light sources 135 to emit light and may cause sound sources 160 to output sound at the same time (or substantially at the same time). For instance, controller 180 may cause first light source 135-1 to emit light and may cause first sound source 160-1 to output, at the same time (or substantially at the same time), first sound 165-1 at the first location. Similarly, controller 180 may cause second light source 135-2 to emit light and may cause second sound source 160-2 to output, at the same time (or substantially at the same time), second sound 165-2 at the second location.

In some implementations, controller 180 may cause sound sources 160 to output the sounds based on a trigger. The trigger may be an indication that guest 170 has interacted with the light emitted by light sources 135 (e.g., the floating images generated based on the light emitted by light sources 135). For instance, the video data may be analyzed to determine whether guest 170 is interacting with the floating images. Additionally, or alternatively, the sensor data may indicate whether guest 170 is interacting with the floating images. Guest 170 may interact with the floating images using a body part of guest 170 (e.g., a hand) and/or using an object.

In some implementations, controller 180 may receive signals (e.g., information) from light sources 135. The signals may indicate whether light sources 135 have emitted light. Based on the signals indicating that light sources 135 have emitted the light, controller 180 may cause sound sources to output the sounds. Controller 180 may be adapted to determine a manner in which light sources 135 are associated with sound sources 160. For example, controller 180 may determine that first light source 135-1 is associated with first sound source 160-1 and/or first sound 165-1, determine that second light source 135-2 is associated with second sound source 160-2 and/or second sound 165-2, and so on. In some implementations, controller 180 may determine the manner in which light sources 135 are associated with sound sources 160 and/or sounds 165 based on information stored in a data structure. For example, the information may indicate that first light source 135-1 is associated with first sound source 160-1 and/or first sound 165-1, determine that second light source 135-2 is associated with second sound source 160-2 and/or second sound 165-2, and so on.

As shown in FIG. 1, first light source 135-1 may emit first light 140-1 toward beamsplitter 120. First light 140-1 may be reflected as reflected first light 145-1 toward retroreflector 110. Retroreflector 110 may receive reflected first light 145-1 and reflect reflected first light 145-1 to generate a first floating image 150-1 at a first location in display area 175. Similarly, second light source 135-2 may emit second light 140-2 toward beamsplitter 120. Second light 140-2 may be reflected as reflected second light 145-2 toward retroreflector 110. Retroreflector 110 may receive reflected second light 145-2 and reflect reflected second light 145-2 to generate a second floating image 150-2 at a second location in display area 175.

In some implementations, controller 180 may monitor signals from light sources 135. The signals may indicate whether light sources 135 have emitted light. Based on determining that light sources 135 have emitted light, controller 180 may cause sound sources 160 to emit sound that is audible at the locations of the floating images. For example, controller 180 may cause first sound source 160-1 to generate first sound 165-1 based on determining that first light source 135-1 has emitted first light 140-1, may cause second sound source 160-2 to generate second sound 165-2 based on determining that second light source 135-2 has emitted second light 140-2, and so on.

In some situations, controller 180 may cause light sources 135 (of light source assembly 130) to sequentially emit light to simulate movement of the floating images. For example, guest 170 may perceive a floating image as gradually moving toward guest 170 or gradually moving away from guest 170. Sound sources 160 may be selected by controller 180 to produce sound corresponding to the sequentially lit light sources 135 that form a moving floating image. For example, controller 180 may cause sound sources 160 to output sound sequentially in an order that matches an order in which light sources 135 are emitting light. Because of the sequential nature of lighting light sources 135, guest 170 will perceive that the floating images are coming towards guest 170 along with corresponding sound. Accordingly, guest 170 may perceive sound gradually moving toward guest 170 as the floating image gradually moves toward guest 170 or may perceive sound gradually moving away from guest 170 as the floating image gradually moves away from guest 170.

The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the example component may perform one or more functions described as being performed by another set of devices of the example component.

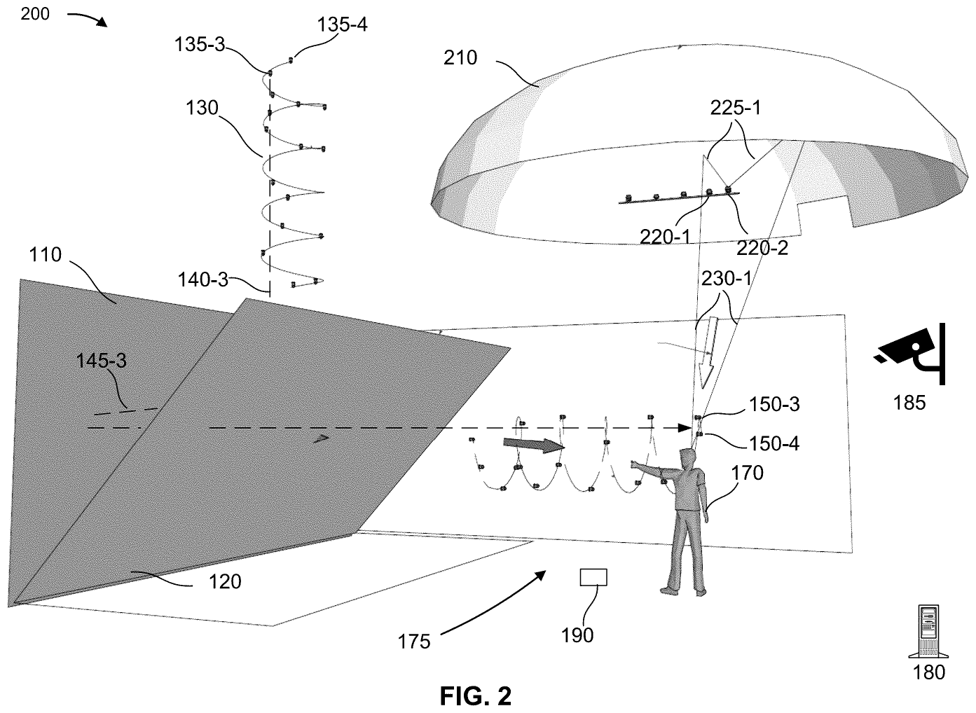

FIG. 2 is a diagram of an example system 200 described herein. Elements of FIG. 1, included in FIG. 2, have been described above. As shown in FIG. 2, system 200 may include a curved reflector 210 (e.g., a curved audio reflector) mounted over guest 170. Curved reflector 210 may provide point source audio near a head of guest 170 that corresponds to an instantaneous position of a floating image. Curved reflector 210 may include an overhead dome that is used to focus sound at positions corresponding to a current location of a floating image (e.g., an illuminated optical image).

As shown in FIG. 2, system 200 may include a first sound source 220-1, a second sound source 220-2, and so on (collectively sound sources 220). In some examples, sound sources 220 may include conventional loudspeakers. Sound sources 220 may be provided at positions corresponding to locations of floating images. As an example, sound sources 220 may be provided at positions corresponding to the head of guest 170 (e.g., which may be the locations of the floating images). Sound from sound sources 220 may be focused on an actual head of guest 170.

As an example, first sound source 220-1 may be aligned with a focal point in curved reflector 210 corresponding to a location of guest 170 near a floating image, so that guest 170 will perceive that the moving floating image is generating sound. Alternatively, sound sources 220 (e.g., the loudspeakers) can be mechanically moved to provide localized sound that follows the sequentially lit objects, or for instance, the image of a moving projection screen.

As shown in FIG. 2, first sound source 220-1 may generate first sound 225-1 toward curved reflector 210. Curved reflector 210 may reflect first sound 225-1 as reflected first sound 230-1 that is focused on the head of guest 170. Controller 180 may cause third light source 135-3 to emit light and may cause first sound source 220-1 to emit first sound 225 based on causing third light source 135-3 to emit light. For example, controller 180 may cause third light source 135-3 to emit light and may cause first sound source 220-1 to emit first sound 225-1 simultaneously (or substantially simultaneously). Additionally, or alternatively, controller 180 may determine that guest 170 has interacted with the light emitted by third light source 135-3 based on video data from camera device 185 and/or sensor data from light sensor 190. Based on determining that guest 170 has interacted with the light, controller 180 may cause first sound source 220-1 to emit first sound 225-1.

The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example component may perform one or more functions described as being performed by another set of devices of the example component.

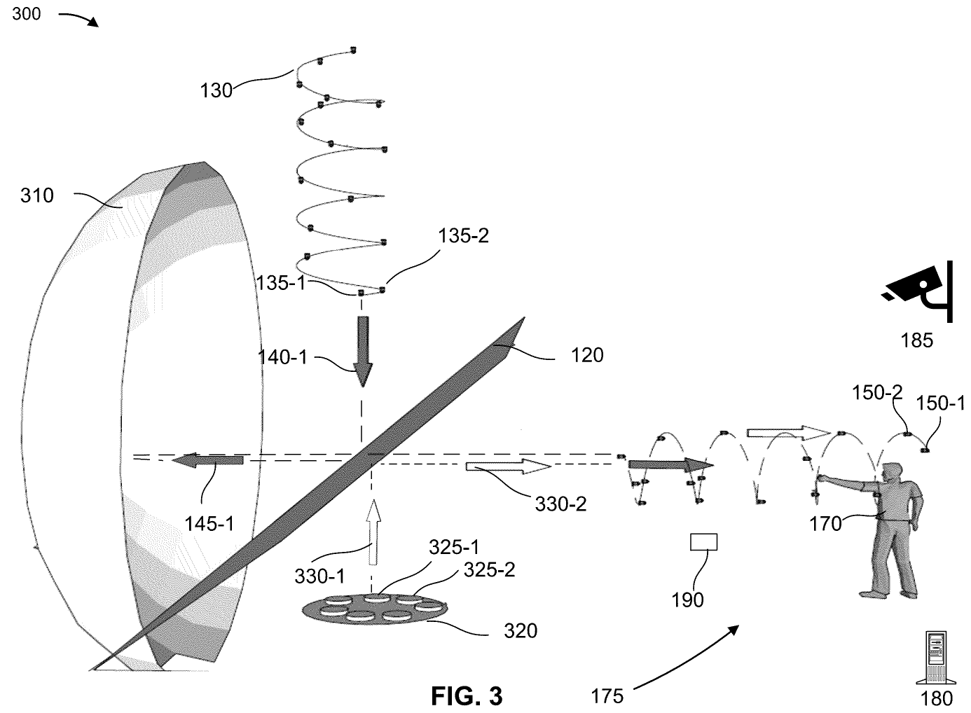

FIG. 3 is a diagram of an example system 300 described herein. As shown in FIG. 3, system 300 may include a reflective element 310 (such as a curved mirror) and an array of sound sources 320 that include first sound source 325-1, second sound source 325-2, and so on (collectively sound sources 325). Reflective element 310 may be used to generate a floating image. Concurrently, sound sources 325 may generate (or output) sound to the sequential position of the image of a currently lit light source by way of a bounce from beamsplitter 120.

As an example, as shown in FIG. 3, first light source 135-1 may generate first light 140-1 toward beamsplitter 120. Beamspliter 120 may reflect a portion of first light 140-1 as reflected first light 145-1. In some examples, beamspliter 120 may be arranged to direct reflected first light 145-1 toward reflective element 310. Reflective element 310 may receive reflected first light 145-1 and reflect reflected first light 145-1 to generate a first floating image 150-1 at a first location in display area 175.

First sound source 325-1 may output first sound 330-1 toward beamsplitter 120, based on first light source 135-1 emitting first light 140-1. Beamsplitter 120 may reflect first sound 330-1 to the first location of first floating image 150-1.

Reflective element 310 may be used to provide a floating image. At the same time, sound sources 325 may output (or beam) their sound to positions of light sources 135 by way of a bounce from beamsplitter 120. In some instances, the position may be a sequential position of the image of the currently lit light source. As such guest 170 may perceive that the image of a sequentially lit light source and a corresponding sound occur at the same time. The sound level for the illuminated image that is the furthest from guest 170 would have its audio set low while one close to the guest would have a louder sound level to enhance the guest's ability to perceive the image coming closer to them with even the sound alone.

The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example component may perform one or more functions described as being performed by another set of devices of the example component.

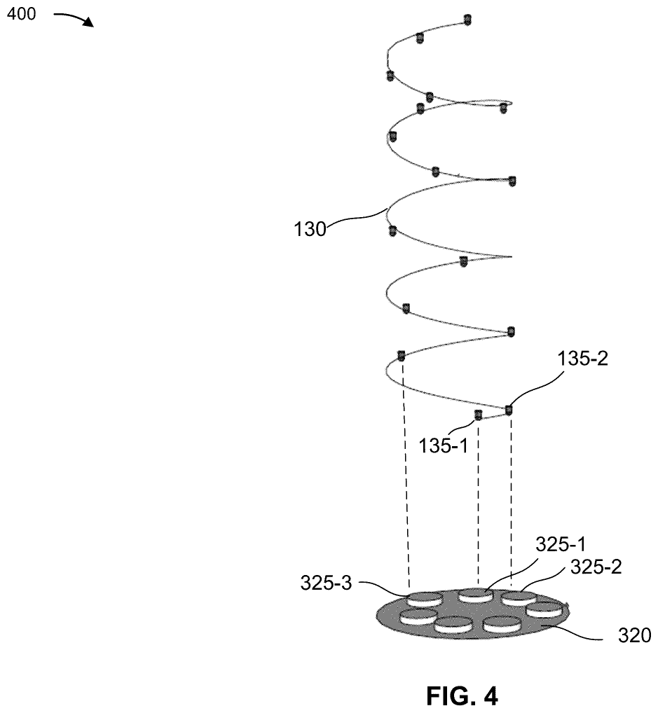

FIG. 4 is a diagram of an example system 400 described herein. As shown in FIG. 4, system 400 may include array of light sources 130 and array of sound sources 320. As shown in FIG. 4, light sources 135 may be vertically aligned with sound sources 325. For example, first light source 135-1 may be vertically aligned with first sound source 325-1, second light source 135-2 may be vertically aligned with second sound source 325-2, and so on.

The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the example component may perform one or more functions described as being performed by another set of devices of the example component.

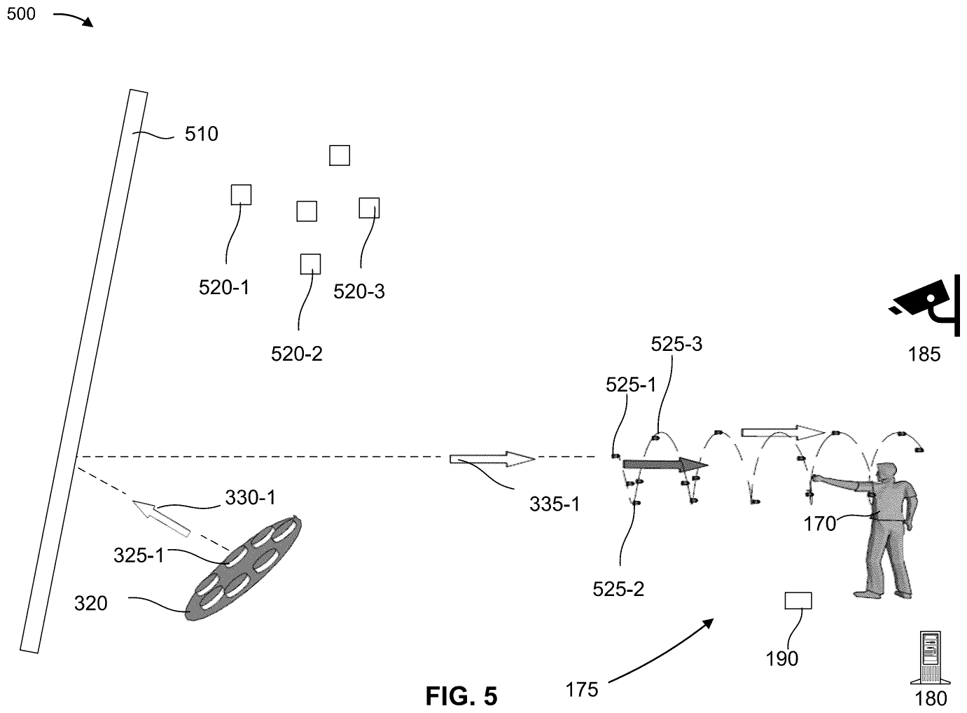

FIG. 5 is a diagram of an example system 500 described herein. As shown in FIG. 5, system 400 may include a hologram element 510 and a plurality of light sources that include first light source 520-1, second light source 520-2, third light source 520-3, and so on (collectively “light source 520”). Hologram element 510 may include a multi-image hologram. For example, hologram element 510 may receive light from different light sources 520 and generate different pictures at different depths. For example, hologram element 510 may receive light from first light source 520-1 and provide first floating image 525-1 at a first location, receive light from second light source 520-2 and provide second floating image 525-2 at a second location, and so on. Hologram element 510 may include a glass plate and/or a mylar surface.

As shown in FIG. 5, first sound source 325-1 may output first sound 330-1 toward hologram element 510. Hologram element 510 may reflect first sound 330-1 as reflected first sound 335-1 that is audible at the first location of first floating image 525-1 without being audible at the second location of second floating image 525-2. Controller 180 may cause first sound source 325-1 to output first sound 330-1 based on determining that first light source 520-1 has emitted light.

The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of the example component may perform one or more functions described as being performed by another set of devices of the example component.

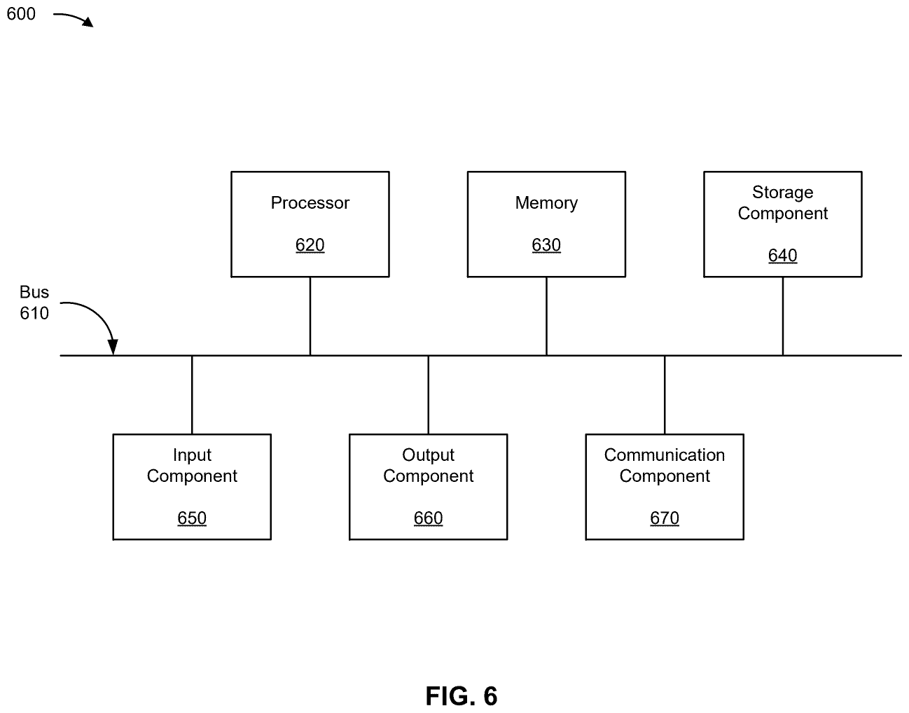

FIG. 6 is a diagram of example components of a device 600, which may correspond to light sources 135, sound sources 160, controller 180, sound source 220, sound source 325, and/or light sources 520. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as guest input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

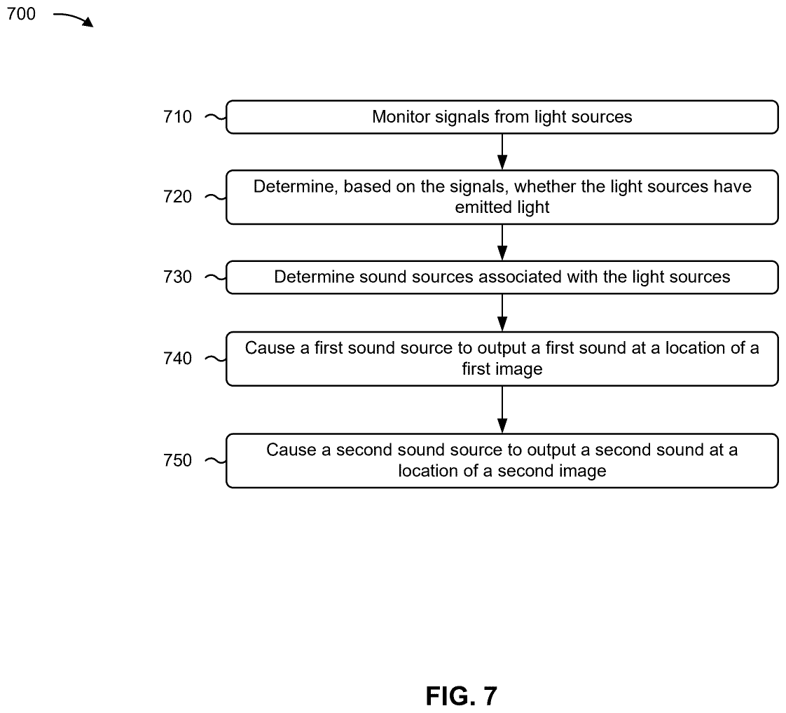

FIG. 7 is a flowchart of an example process 700 relating to generating sounds at locations of floating images. In some implementations, one or more process blocks of FIG. 7 may be performed by a controller (e.g., controller 180). In some implementations, one or more process blocks of FIG. 7 may be performed by another device or a group of devices separate from or including the processor, such as a light source assembly a camera device (e.g., light source assembly 130) and/or sound sources (e.g., sound sources 160). Additionally, or alternatively, one or more process blocks of FIG. 7 may be performed by one or more components of device 600, such as processor 620, memory 630, storage component 640, input component 650, output component 660, and/or communication component 670.

As shown in FIG. 7, process 700 may include causing a first light source to emit first light to cause a first image to be provided at a first location (block 710). For example, the controller may cause a first light source to emit first light to cause a first image to be provided at a first location. In some situations, the controller may be connected to the light sources via a first network that includes one or more wired and/or wireless networks. Additionally, or alternatively, the controller may be connected to sources (e.g., sound sources 160, sound source 220, and/or sound source 325) via a second network includes one or more wired and/or wireless networks.

As an example, the first network may include Ethernet switches. Additionally, or alternatively, the first network may include a cellular network, a public land mobile network (PLMN), a local area network (LAN), a wide area network (WAN), a private network, the Internet, and/or a combination of these or other types of networks. The second network may be similar to the first network. In some situations, the first network may include the second network.

As further shown in FIG. 7, process 700 may include causing a second light source to emit second light to cause a second image to be provided at a second location (block 720). For example, the controller may cause a second light source to emit second light to cause a second image to be provided at a second location.

As further shown in FIG. 7, process 700 may include causing a first sound source to output a first sound at the first location based on the first light source emitting the first light (block 730). For example, the controller may cause a first sound source to output a first sound at the first location based on the first light source emitting the first light. The controller may cause the first sound source to output the first sound simultaneously with causing the first light source to emit the first light. Alternatively, the controller may cause the first sound source to output the first sound based on determining that a guest has interacted with the first light.

The first sound may be output in manner that causes the first sound to be audible at the first location of the first image without being audible at other locations. Alternatively, the first sound may be output in manner that causes the first sound to be audible in an area that includes the first location of the first image without being audible in other areas.

As further shown in FIG. 7, process 700 may include causing a second sound source to output a second sound at the second location based on the second light source emitting the second light (block 740). For example, the controller may cause a second sound source to output a second sound at the second location based on the second light source emitting the second light. The controller may cause the second sound source to output the second sound simultaneously with causing the second light source to emit the second light. Alternatively, the controller may cause the second sound source to output the second sound based on determining that a guest has interacted with the second light.

The second sound may be output in a manner that causes the second sound to be audible at the second location of the second image without being audible at other locations. Alternatively, the second sound may be output in manner that causes the second sound to be audible in area that includes the second location of the second image without being audible in other areas.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

1. A system, comprising:
a first light source to emit first light, at least a portion of the first light processed to provide a first image at a first location;
a second light source to emit second light, at least a portion of the second light processed to provide a second image at a second location different from the first location;
a first sound source positioned separate from, but in acoustical communication with, the first location, the first sound source to output a first sound audible at the first location;
a second sound source positioned separate from, but in acoustical communication with, the second location, the second sound source to output a second sound audible at the second location; and
a controller configured to:
cause, based on the first light that has been emitted, the first sound source to output the first sound, and
cause, based on the second light that has been emitted, the second sound source to output the second sound.

2. The system of claim 1, wherein the first sound is inaudible at the second location and
the second sound is inaudible at the first location.

3. The system of claim 1, wherein the first sound source includes a first ultrasonic transducer and
the second sound source includes a second ultrasonic transducer.

4-7. (canceled)

8. A system, comprising:
a light source to emit first light and second light, the first light processed to provide a first image at a first location, and the second light processed to provide a second image at a second location different from the first location;
a first sound source to output a first sound that is audible at the first location and inaudible at the second location; and
a second sound source to output a second sound that is audible at the second location and inaudible at the first location.

9. The system of claim 8, further comprising a controller configured to:
detect whether a guest has interacted with at least one of the first image or the second image;
responsive to the detection that the guest has interacted with the first image, cause the first sound source to output the first sound; and
responsive to the detection that the guest has interacted with the second image, cause the second sound source to output the second sound.

10-12. (canceled)

13. The system of claim 8, wherein at least one of the first sound source or the second sound source includes an first ultrasonic transducer.

14. (canceled)

15. (canceled)

16. The system of claim 8, wherein the first sound source outputs the first sound in a first area that includes the first location and
the second sound source outputs the second sound in a second area that includes the second location.

17. A method comprising:
causing, by a controller, a first light source to emit first light such that a first image is provided at a first location;
causing, by the controller, a second light source to emit second light such that a second image is provided at a second location;
responsive to the first light source emitting the first light, causing, by the controller, a first sound source to output a first sound to the first location; and
responsive to the second light source emitting the second light, causing, by the controller, a second sound source to output a second sound to the second location.

18. The method of claim 17, further comprising:
determining, by the controller, that a guest has interacted with the first image or the second image;
responsive to the determination that the guest has interacted with the first image, causing, by the controller, the first sound source to output the first sound; and
responsive to the determination that the guest has interacted with the second image, causing, by the controller, the second sound source to output the second sound.

19. (canceled)

20. The method of claim 17, wherein:
the first sound source outputs the first sound to a first area that includes the first location;
the second sound source outputs the second sound to a second area that includes the second location; and
the method further comprises:
determining, by the controller, that the first light or the second light is emitted to the first area or the second area; and
selectively causing, by the controller, the first sound to be output based on determining that the first light is emitted to the first area or the second sound to be output based on determining that the second light is emitted to.

21. The system of claim 1, further comprising a beamsplitter configured to:
reflect the at least a portion of the first light as reflected first light, and
reflect the at least a portion of the second light as reflected second light.

22. The system of claim 21, further comprising a retroreflector comprising a retroreflective material and a reflective surface, the retroreflector configured to:
reflect the reflected first light to provide the first image at the first location, and
reflect the reflected second light to provide the second image at the second location.

23. The system of claim 22, wherein the beamsplitter is positioned between the retroreflector and the first location, the beamsplitter at a non-zero angle with respect to the retroreflector.

24. The system of claim 1, wherein the controller is further configured to:
receive signals from the first light source related to the first light source emitting the first light; and
responsive to receiving the signals, cause the first sound source to output the first sound.

25. The system of claim 1, further comprising a camera, wherein the controller is further configured to:
determine, based upon video data from the camera, that a guest is interacting with the first image; and
responsive to the determination that the guest is interacting with the first image, cause the first sound source to output the first sound.

26. The system of claim 1, further comprising a camera and light sensors at the first location, wherein the controller is further configured to:
determine, based upon video data from the camera and the light sensors, that the first light has been obstructed by a guest; and
responsive to the determination that the first light is obstructed, cause a third sound source positioned separate from, but in acoustical communication with, the first location, to output a third sound audible at the first location.

27. The system of claim 8, further comprising:
a beamsplitter configured to:
reflect a portion of the first light as reflected first light, and
reflect a portion of the second light as reflected second light; and
a reflective element configured to:
reflect the reflected first light to provide the first image at the first location, and
reflect the reflected second light to provide the second image at the second location.

28. The system of claim 27, wherein the beamsplitter is further configured to:
reflect the first sound such that the first sound is audible at the first location, and
reflect the second sound such that the second sound is audible at the second location.

29. The system of claim 9, wherein controller is configured to detect whether the guest has interacted with at least one of the first image or the second image based upon video data from a camera.

30. The method of claim 17, wherein the first sound source is positioned separate from, but in acoustical communication with, the first location, and the second sound source is positioned separate from, but in acoustical communication with, the second location.
